(19) United States
(12) Patent Application Publication
(10) Pub. No.: US 2010/0006556 A1
(43) Pub. Date: Jan. 14, 2010

(54) ATMOSPHERIC HEATER

(76) Inventor: WILLIAM HOME, Taipei (TW)

Correspondence Address: LEONG C LEI, PMB # 1008, 1867 YGNACIO VALLEY ROAD, WALNUT CREEK, CA, 94598, US

(21) Appl. No.: 12/171,308

(22) Filed: Jul. 11, 2008

(51) Int. Cl. H05B 1/00

(52) U.S. Cl. 219/220

(57) ABSTRACT

An atmospheric heater has opposite side walls each forming a groove for receiving a retention rail with an opening of the retention rail exposed to receive and retain a fogged light-transmitting tube, which is spaced from a bottom wall of the retention rail to define a first channel. A circuit board that carries light-emitting diodes is fixed inside the tube and opposite to the tube wall where light is given off to thereby form a second channel between the circuit board and the tube wall. Heat emitted from the heater travels through the first and second channels for penetrating vertically in a down-to-up direction to generate a chimney effect for heat dissipation in order to prevent the light-emitting diodes from over-heating and burnout during the operation thereof and also provide a dim lighting effect on opposite sides of the heater.

### BACKGROUND OF THE INVENTION

(a) Technical Field of the Invention

The present invention relates to an atmospheric heater having an enclosure having opposite side walls from which vertical bar like dim lighting is given off to provide an atmospheric lighting effect and form atmospheric lighting decoration.

(b) Description of the Prior Art

A heater is a commonly used warm keeping device. Besides the long known wall fireplace, various newly developed heaters are also available, such as gas heater, electrically-heated oil heater, and electrical heater. These modern heaters are advantageous in maneuverability in accordance with space arrangement and partition requirement. However, atmospheric or romantic effect that is provided by a fireplace cannot be made by the modern heaters.

Although lighting can be easily made with indoor lighting facility in the nighttime, yet people often deny such modern lighting, which is often of more than desired brightness, when they are sitting in front of a fireplace and surrounded by such a romantic atmosphere. The modern heaters do not have means to generate deep and romantic lighting resembling the dim and jumping light from a fireplace.

Thus, the present inventor, basing on his years' experience in development and research, creates an atmospheric heater that overcomes the drawbacks discussed above.

### SUMMARY OF THE INVENTION

The primary purpose of the present invention is to provide an atmospheric heater that gives off dim lighting of vertical bars from opposite sides thereof to enhance an atmospheric lighting effect. The heater has opposite side walls each forming therein a vertical groove for receiving a retention rail in such a way that the retention rail has an opening that is exposed outside the side wall of the heater for slidably receiving and retaining a fogged light-transmitting tube, which is spaced from a bottom wall of the retention rail to define a first channel. A circuit board that carries an array of light-emitting diodes is positioned and pinchingly fixed inside the fogged light-transmitting tube at one side that is opposite to the side where light is given off to thereby form a second channel between the circuit board and the wall of the fogged light-transmitting tube where the light is given off. The circuit board comprises a power cable extending through the fogged light-transmitting tube and the retention rail into a heater enclosure to connect to a power source. Thus, heat emitted from the heater travels through the first channel and the second channel for penetrating vertically in a down-to-up direction to generate a chimney effect for dissipation in order to prevent the light-emitting diodes from over-heating and burnout during the operation thereof and also enhancement of atmospheric lighting effect is realized. This is the primary objective of the present invention.

The atmospheric heater in accordance with the present invention employs light-emitting diodes as a light source for atmospheric lighting emitted from sides of the heater enclosure. Light-emitting diodes are considered the most power-saving illumination devices and do not consume a great amount of energy, whereby safety of lighting decoration and less consumption of power can both be realized. This is another objective of the present invention. Further, the atmospheric heater in accordance with the present invention may further form a third channel inside the fogged light-transmitting tube opposite to the space between the circuit board and the side wall of the fogged light-omitting tube where the light is emitted, whereby the heat that is emitted from the heater is guided to penetrate in a down-to-up direction through the first channel, the second channel, and the third channel to provide a chimney effect for heat dissipation. Since the number of partitioned channels is increased, the light-emitting diodes can be better protected from over-heating and burnout during the operation thereof. This is a further objective of the present invention.

Further, the atmospheric heater in accordance with the present invention may farther comprises at least one heat dissipation block that has a corrugated and thus increased surface area and is of excellent thermal conductivity received in the third channel to enhance heat dissipation performance, allowing for efficient heat conduction and temperature reduction through the third channel during operation of the light-emitting diodes and the heater. This is yet a further objective of the present invention.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an atmospheric heater constructed in accordance with the present invention;

FIG. 2 is a front view of the atmospheric heater of the present invention;

FIG. 3 is an exploded view of the atmospheric heater with two side fogged light-transmitting tubes detached;

FIG. 4 is a cross-sectional view showing the fogged light-transmitting tube of FIG. 3 fit in a retention rail, together with an in-tube circuit board;

FIG. 5 s a perspective view of the fogged light-transmitting tube and the in-tube circuit board of FIG. 3 taken from a back side thereof;

FIG. 6 is a cross-sectional view demonstrating the atmospheric lighting effect generated in the use of the atmospheric heater in accordance with the present invention;

FIG. 7 is a cross-sectional view showing a fogged light-transmitting tube fit in a retention rail, together with an in-tube circuit board, in accordance with another embodiment of the present invention; and

FIG. 8 is a cross-sectional view showing a fogged light-transmitting tube fit in a retention rail, together with an in-tube circuit board, in accordance with a further embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

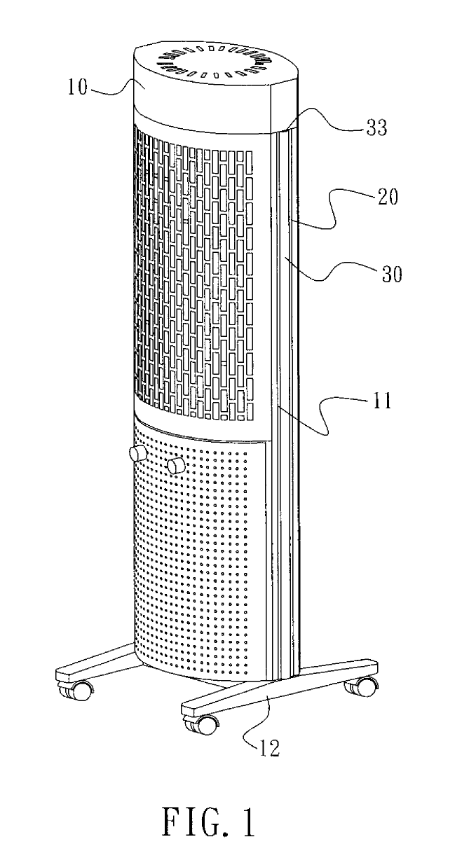

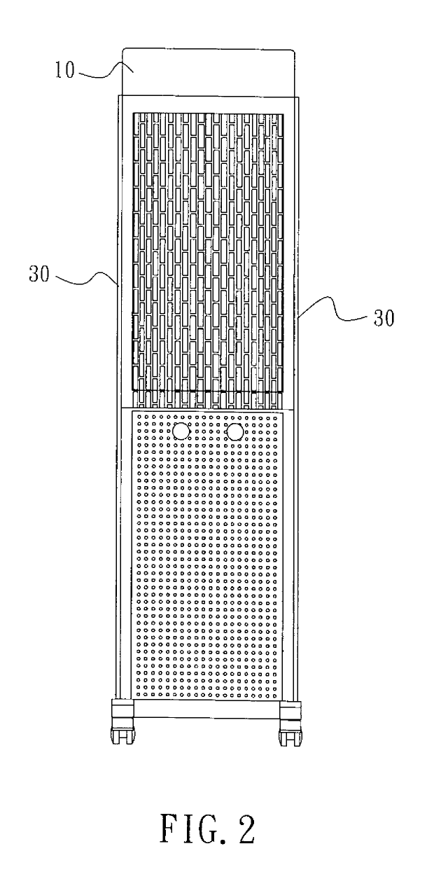

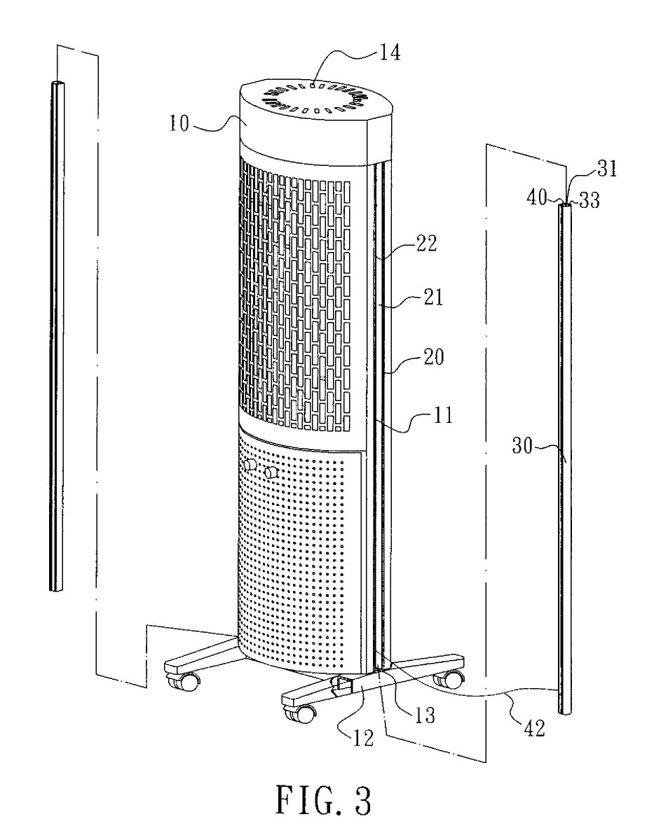

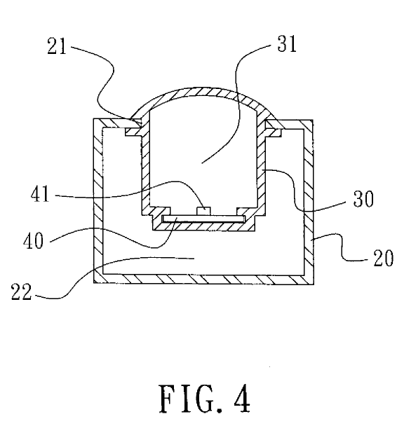

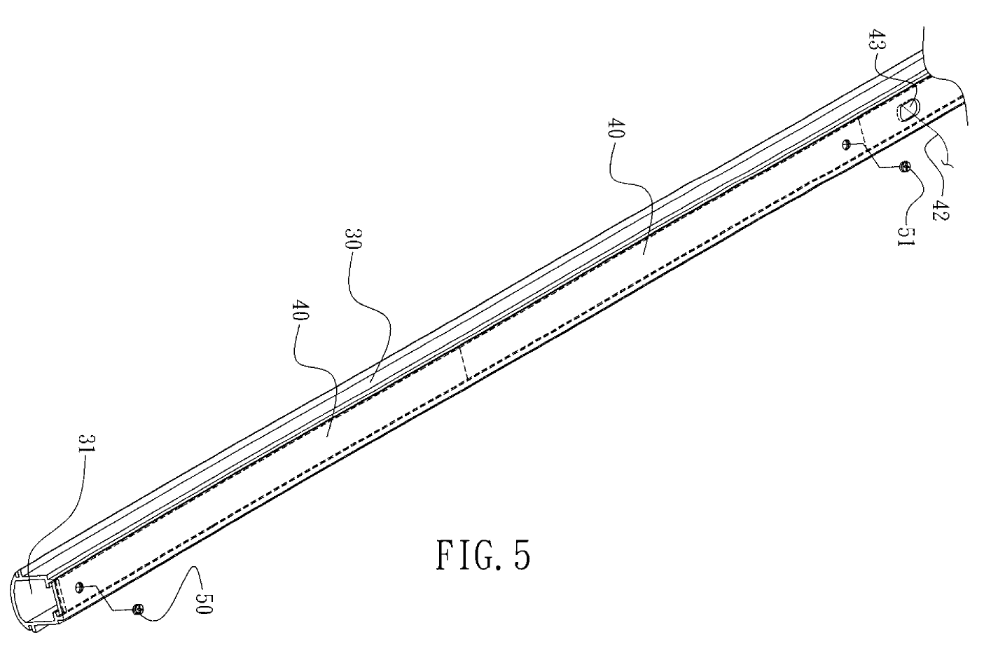

With reference to the drawings and in particular to FIGS. 1-5, of which FIG. 1 is a perspective view showing an atmospheric heater constructed in accordance with the present invention, FIG. 2 is a front view of the atmospheric heater of the present invention, FIG. 3 is an exploded view of the atmospheric heater with two side fogged light-transmitting tubes detached, FIG. 4 is a cross-sectional view showing the fogged light-transmitting tube of FIG. 3 fit in a retention rail, together with an in-tube circuit board, and FIG. 5 is a perspective view of the fogged light-transmitting tube and the in-tube circuit board of FIG. 3 taken from a back side thereof, it is apparent from these drawings that the atmospheric heater in accordance with the present invention comprises a heater enclosure 10 having opposite side walls each forming therein a vertical groove 11 for receiving a retention rail 20 in such a way that the retention rail 20 has an opening 21 that is exposed outside the side wall of the heater for slidably receiving a fogged light-transmitting tube 30, which can be a clear or colored acrylic tube. The tube 30 is spaced from a bottom (back) wall of the retention rail 20 to define a first channel 22. Inside the fogged light-transmitting tube 30, at one side that is opposite to the side where light is given off, a circuit board 40 carrying an array of light-emitting diodes (LEDs) 41 is positioned and pinchingly fixed whereby a second channel 31 is formed between the circuit board 40 and the side wall of the fogged light-transmitting tube 30 where the light is given off.

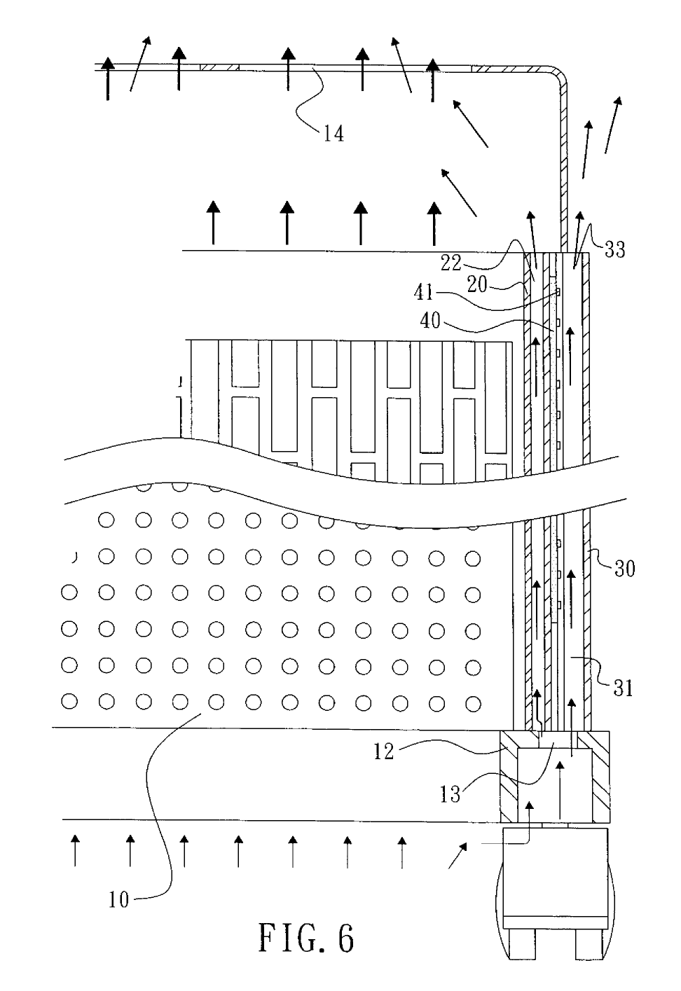

As shown in FIG. 5, a power cable 42 of the circuit board 40 runs through a cable opening 43 defined in the fogged light-transmitting tube 30 and the retention rail to further extend into and connected to a corresponding power source arranged inside the heater enclosure 10. Plastic fasteners 50, 51, such as blots, extend through the back wall of the fogged light-transmitting tube 30 and engage the circuit board 40 for fastening. Back to FIG. 3, the heater enclosure 10 has two stands 12 each forming a through hole 13 at a central portion substantially corresponding to and supporting the retention rail 20 and the fogged light-transmitting tube 30. The stands 12 are bar-like members having an open bottom side. Thus, as shown in FIG. 6 that is a cross-sectional view demonstrating the atmospheric lighting effect generated in the use of the atmospheric heater of the present invention, the heat sideways emitted from the heater travels from the open bottoms of the two stands 12 of the heater enclosure 10, through the holes 13 to get into the first channel 22 and the second channel 31, further penetrating vertically in a down-to-up direction to eventually radiate outward through an exposed upper end opening 33 of the tube 30 and radiation apertures 14 defined in a top wall of the heater enclosure 10 to provide a chimney effect for heat radiation, so that the LEDs 41 will not burn out due to over-heating during the operation thereof. In this way, the lighting function that enhances the atmospheric effect can maintain excellently operable.

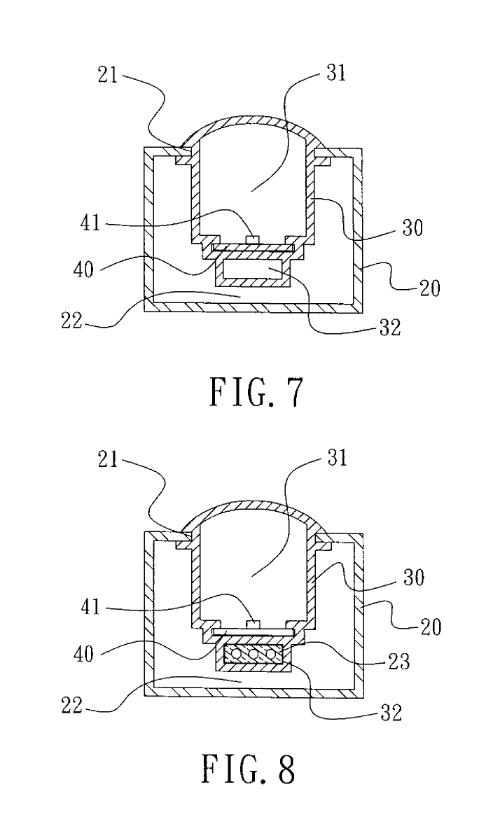

As shown in FIG. 7, the atmospheric heater in accordance with the present invention can be further provided, with a third channel 32 that is formed inside the fogged light-transmitting tube 30 at a wall surface opposite to the space from the circuit board 40 to the side wall of the fogged light-transmitting tube 30 where the light is emitted, whereby the heat that is sideways emitted from the heater is guided to penetrate in a down-to-up direction through the first channel 22, the second channel 31, and the third channel 32 to provide a chimney effect for heat dissipation. Thus, during the operation of the LEDs 41, due to the increased number of partitioned channel, protection against burnout by over-heating can be realized. As shown in FIG. 8, it is also feasible to provide one or more heat dissipation blocks 33 that has corrugated and thus increased surface area and is of excellent thermal conductivity inside the third channel 32 to enhance heat dissipation performance, allowing for efficient heat conduction and temperature reduction through the third channel 32 during the operation of the LEDs 41 and the heater.

To conclude, the atmospheric heater in accordance with the present invention can give off dim lighting of vertical bars to provide an atmospheric lighting effect.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An atmospheric heater characterized in that the heater has opposite side walls each forming therein a vertical groove for receiving a retention rail in such a way that the retention rail has an opening that is exposed outside the side wall of the heater for slidably receiving and retaining a fogged light-transmitting tube, the tube being spaced from a bottom wall of the retention rail to define a first channel, a circuit board carrying an array of light-emitting diodes and positioned and pinchingly fixed inside the fogged light-transmitting tube at one side that is opposite to the side where light is given off to thereby form a second channel between the circuit board and the wall of the fogged light-transmitting tube where the light is given off, the circuit board comprising a power cable extending through the fogged light-transmitting tube and the retention rail into a heater enclosure to connect to a power source, whereby heat emitted from the heater travels through the first channel and the second channel for penetrating vertically in a down-to-up direction to generate a chimney effect for dissipation in order to prevent the light-emitting diodes from over-heating and burnout due to operation thereof and also enhancement of atmospheric lighting effect is realized.

2. The atmospheric heater as claimed in claim 1 further forming a third channel inside the fogged light-transmitting tube opposite to the space between the circuit board and a wall of the fogged light-transmitting tube where the light is emitted, whereby the heat that is emitted from the heater is guided to penetrate in a down-to-up direction trough the first channel, the second channel, and the third channel to provide a chimney effect for heat dissipation.

3. The atmospheric heater as claimed in claim 2 further comprising at least one heat dissipation block that has a corrugated and thus increased surface area and is of excellent thermal conductivity received in the third channel inside the fogged light-transmitting tube to enhance heat dissipation performance, allowing for efficient heat conduction and temperature reduction through the third channel during operation of the light-emitting diodes and the heater.

4. The atmospheric heater as claimed in claim 1, wherein the fogged light-transmitting tube comprises a clear acrylic tube.

5. The atmospheric heater as claimed in claim 2, wherein the fogged light-transmitting tube comprises a clear acrylic tube.

6. The atmospheric heater as claimed in claim 3, wherein the fogged light-transmitting tube comprises a clear acrylic tube.

7. The atmospheric heater as claimed in claim 1, wherein the fogged light-transmitting tube comprises a colored acrylic tube.

8. The atmospheric heater as claimed in claim 2, wherein the fogged light-transmitting tube comprises a colored acrylic tube.

9. The atmospheric heater as claimed in claim 3, wherein the fogged light-transmitting tube comprises a colored acrylic tube.

10. The atmospheric heater as claimed in claim 1, wherein the heater comprises a heater enclosure having two stands each forming a through hole at a central portion substantially corresponding to and supporting the retention rail and the fogged light-transmitting tube, the stands being bar-like members having an open bottom, whereby heat emitted from the heater travels from the open bottoms of the two stands of the heater enclosure through the holes to get into the first channel and the second channel and filter penetrate vertically in a down-to-up direction to eventually radiate outward through an exposed upper end opening of the tube and radiation apertures defined in a top wall of the heater enclosure to provide a chimney effect for heat radiation.

11. The atmospheric heater as claimed in claim 2, wherein the heater comprises a heater enclosure having two stands each forming a through hole at a central portion substantially corresponding to and supporting the retention rail and the fogged light-transmitting tube, the stands being bar-like members having an open bottom, whereby heat emitted from the heater travels from the open bottoms of the two stands of the heater enclosure through the holes to get into the first channel, the second channel, and the third channel and farther penetrate vertically in a down-to-up direction to eventually radiate outward through an exposed upper end opening of the tube and radiation apertures defined in a top wall of the heater enclosure to provide a chimney effect for heat radiation.

12. The atmospheric heater as claimed in claim 3, wherein the heater comprises a heater enclosure having two stands each forming a through hole at a central portion substantially corresponding to and supporting the retention rail and the fogged light-transmitting tube, the stands being bar-like members having an open bottom, whereby heat emitted from the heater travels from the open bottoms of the two stands of the heater enclosure through the holes to get into the first channel, the second channel, and the third channel and further penetrate vertically in a down-to-up direction to eventually radiate outward trough an exposed upper end opening of the tube and radiation apertures defined in a top wall of the heater enclosure to provide a chimney effect for heat radiation.
